(19) United States
(12) Patent Application Publication
(10) Pub. No.: US 2004/0145804 A1
(43) Pub. Date: Jul. 29, 2004

(54) Microscope lens and the use of a microscope lens of this type in a microscope

(76) Inventor: Thomas Engel, Niedernissa (DE)

Correspondence Address: Douglas J Christensen, Patterson Thuente Skaar & Christensen, 4800 IDS Center, 80 South Eighth Street, Minneapolis, MN, 55402, US

(21) Appl. No.: 10/472,331

(22) PCT Filed: Jun. 13, 2002
(86) PCT No.: PCT/EP02/06522

(30) Foreign Application Priority Data
Jul. 19, 2001 (DE) 101 35 320.0

(51) Int. Cl. G02B 21/00

(52) U.S. Cl. 359/368

(57) ABSTRACT

In a microscope objective (1) comprising a housing (2), which is connectable to an objective mount of a microscope and comprises a light inlet opening (6), and further comprising an optical system (8) arranged inside the housing (2), an image-detecting element (19) is provided and light entering through the light inlet opening (6) is directed to the image-detecting element (9) by means of the optical system (8) and is not coupled into a beam path of the microscope, said beam path being located following the microscope objective.

The invention relates to a microscope objective comprising a housing which is connectable to an objective mount of a microscope and comprises a light inlet opening, and further comprising an optical system arranged inside said housing. Further, the invention relates to the use of such microscope objective in a microscope.

In most cases, a microscope comprises several microscope objectives, which are all connected to the objective mount (e.g. a revolving nosepiece), using which the desired microscope objective may be moved into its working position. Since, in microscopic examinations, the location of observation on the specimen has to be determined or controlled, microscope objectives usually have different magnification factors so that, prior to a highly magnified observation, a microscope objective having smaller magnification is used to determine whether the specimen is correctly positioned.

The positioning of the specimen is of particular importance in microscopic observations where the system provides no visual (or binocular) observation, as is often the case with microscopes used for inspection of masks employed in the manufacture of semi-conductors.

Moreover, such inspection is preferably carried out using UV light (e.g. 193 nm, 157 nm), whereas the photomacrograph is taken using light at a greater wavelength, so that beam splitting is required in the beam path following the revolving nosepiece, which leads to an expensive and complicated optical assembly.

Further, current autofocussing devices operate at wavelengths of e.g. 600-800 nm, so that, also for this reason, beam splitting is effected behind the revolving nosepiece, which complicates the optical assembly of the microscope.

In view thereof, it is an object of the present invention to improve a microscope objective of the above-mentioned type in a manner allowing a simplification of the optical assembly of the microscope, in which the microscope objective is used.

According to the invention, this object is achieved by the above-mentioned microscope objective in that an image-detecting element is provided and that light entering through the light inlet opening is directed to the image-detecting element via the optical system and is not coupled into an optical path of the microscope, said optical path being located following the microscope objective. Due to the image-detecting element and the optical system, beam splitting is no longer required in the beam path of the microscope following the objective mount, because the light is incident on the image-detecting element and is no longer coupled into the beam path.

Thus, it is possible, in an easy manner, to take the desired photomacrograph, the size of said photomacrograph depending substantially on the magnification factor of the optical system. After taking the photomacrograph, the specimen may be suitably positioned, whereupon the objective mount may be used to place a magnifying objective, which is attached thereto and yields the desired magnification, in a working position.

Further, when using the microscope objective according to the invention in a microscope, focussing may be effected already when taking the photomacrograph, so that a sharp image may be generated immediately during subsequent use of another microscope objective.

In particular, the image-detecting element may be connected to the microscope objective housing. This will safeguard the optimal arrangement of the image-detecting elements even when moving the microscope objective.

The microscope objective according to the invention may preferably be employed in microscopes or inspection systems for the semi-conductor industry and in microscopes or inspection systems using UV light (e.g. 365, 266, 248, 213, 211, 193, 157 nm) for examination.

In a preferred further embodiment of the microscope objective according to the invention, the image-detecting element is arranged inside the housing. On the one hand, this results in a very compact microscope objective and, on the other hand, effective protection of the image-detecting element, e.g. against soiling, is realized in a simple manner.

In particular, it is also possible that the housing of the microscope objective according to the invention may further comprise a light outlet opening and that the image-detecting element may be arranged outside the housing. Advantageously, a deflecting element (e.g. a mirror) may be provided in the housing so as to direct coupled-in light through the light outlet opening which, in this case, is provided in the side wall. Therefore, the image-detecting element may be arranged laterally of the housing, so that the length of the objective may be very short.

There may also be provided an optical device between the housing and the image-detecting element, using which device desired corrections may be carried out, for example. Thus, using this arrangement of the image-detecting element, a longer beam path may be provided withouth having to increase the length of the objective.

The image-detecting element may also be externally attached to the housing so as to cover the light outlet opening. In particular, the light outlet opening may extend through a screw thread of the microscope objective, with the image-detecting element then being fittable onto the screw thread. Since the image-detecting element is attached to the outside of the housing, maintenance and, in particular, a possibly required replacement of the image-detecting element are very easy to effect.

In a preferred further embodiment of the microscope objective according to the invention, an evaluating device is arranged outside the housing, said device being able to receive electrical image signals generated by the image-detecting element. Since the evaluating device is arranged outside the housing, the entire internal space of the housing may be used for the optical system and for the image-detecting element, allowing the optical assembly to be realized more easily. This is advantageous, in particular, if the longitudinal dimensions of the microscope objective are fixed, e.g. in order to enable use of the microscope objective in already existing microscopes.

In particular, the evaluating device may be attached to the outside of the housing of the microscope objective according to the invention. This allows a spatially very compact realization of the image-detecting system (image-detecting element and evaluating device), with the housing having sufficient space for the necessary optical components.

It is also possible, of course, to arrange the evaluating device inside the microscope housing, if there is sufficient space for it. By this measure, the evaluating device is then advantageously protected mechanically by the housing.

In a particularly preferred further embodiment of the microscope objective according to the invention, said objective comprises a dark field channel via which the specimen to be examined may be illuminated with light from the microscope in which the microscope objective according to the invention is used. Thus, a means of illuminating the specimen to be examined is also realized, in an extremely compact manner, in the microscope objective according to the invention.

In addition to illumination via the dark field channel, illumination by transmitted light, as conventionally used in microscopes, or, if there is sufficient space in the microscope objective according to the invention, illumination by incident light may be employed. Further, it is possible to provide a separate source of illumination, light from this source of illumination being directable to the specimen, e.g., either through an optical fiber or directly by the source of illumination.

In a preferred embodiment of the microscope objective according to the invention, a light source for illumination of the specimen to be examined is provided in the housing. Such light source may comprise a light bulb, a halogen lamp, an LED, or a laser diode. By arranging said light source inside the housing, with the light for illumination preferably being incident on the specimen to be examined through the light inlet opening and, in particular, through at least part of the optical system, an extremely compact microscope objective having its own light source may be realized. Also, advantageously, the used part of the optical system, or the used optical system itself, may be employed as an optical illumination system.

In particular, the image-detecting element of the microscope objective according to the invention may comprise a CCD image sensor. Such CCD sensors are conventional optical elements providing an extremely high resolution at very small spatial dimensions, so that the microscope objective may be realized in a very compact manner.

The image-detecting element may also comprise other electronic image sensors, such as photodiodes, which may be arranged, for example, in a matrix, quadrant diodes, or position-sensitive detectors (PSD).

Further, a second image-detecting element and a beam splitter may be provided in the microscope objective according to the invention, with the light entering through the light inlet opening being split into two partial beam paths so as to illuminate both image-detecting elements. Preferably, at least one of the two image-detecting elements is provided outside the housing. In this embodiment, advantageously, two different magnifications may be simultaneously obtained using the two image-detecting elements, so as to provide a better overview when positioning the specimen. As the beam splitter, a semi-transparent mirror may be used, for example, which reflects part of the light incident thereon and transmits the remaining part.

The optical system in the microscope objective according to the invention and also the optical device may each comprise refractive and/or diffractive optical elements. Further, use may also be made of lenses having locally varying diffraction indices.

The use of the microscope objective according to the invention is particularly advantageous in a microscope comprising an objective mount, an observing objective connected to the objective mount and, arranged following the objective mount, an observing optical system, in which the light gathered from the specimen and received through the observing objective is coupled in, when the observing objective is placed in its working position by means of the objective mount, the microscope objective according to the invention being connected to the objective mount and movable into its working position by the latter.

As the objective mount, a known revolving nosepiece or any other mount suitable for holding several objectives and for selectively moving them into a working position may be used.

The invention shall be explained in more detail below, by way of example, with reference to the drawings, wherein:

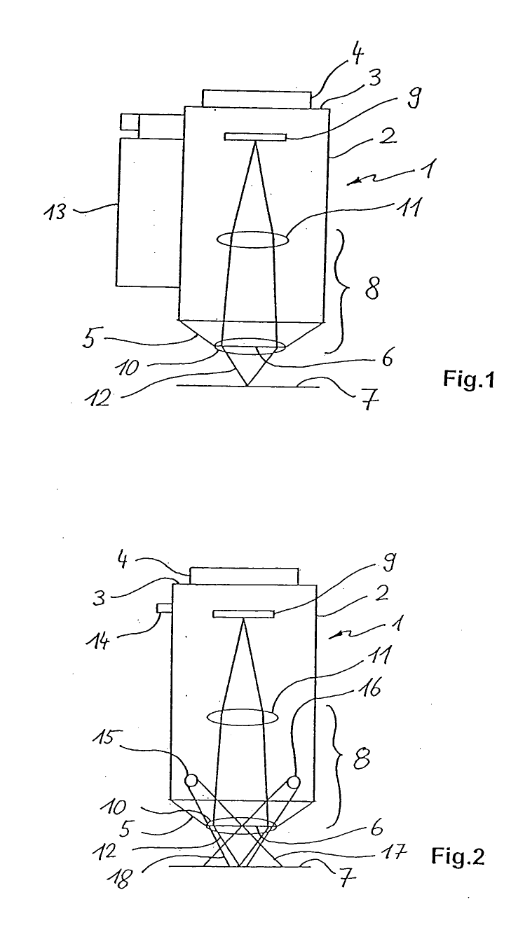

FIG. 1 shows a schematic view of a first embodiment of the microscope objective according to the invention;

FIG. 2 shows a schematic view of a second embodiment of the microscope objective according to the invention;

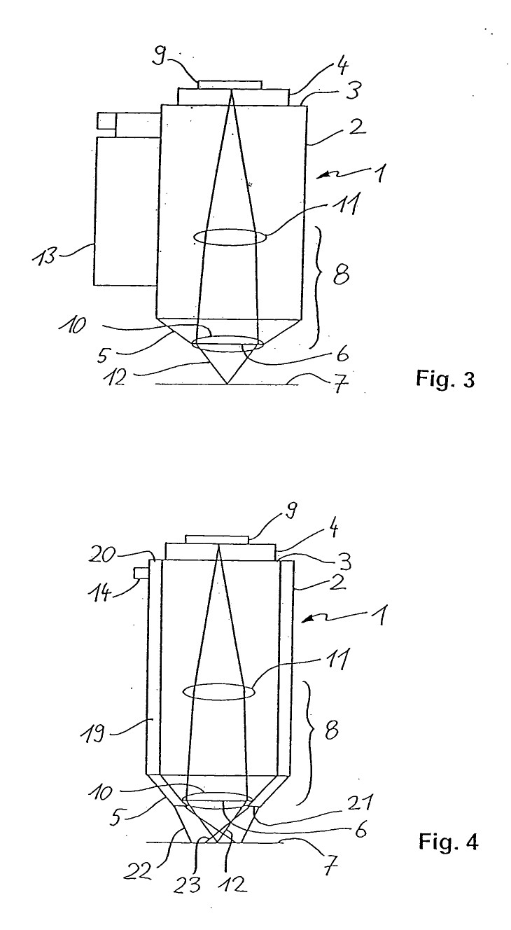

FIG. 3 shows a schematic view of a third embodiment of the microscope objective according to the invention;

FIG. 4 shows a schematic view of a fourth embodiment of the microscope objective according to the invention;

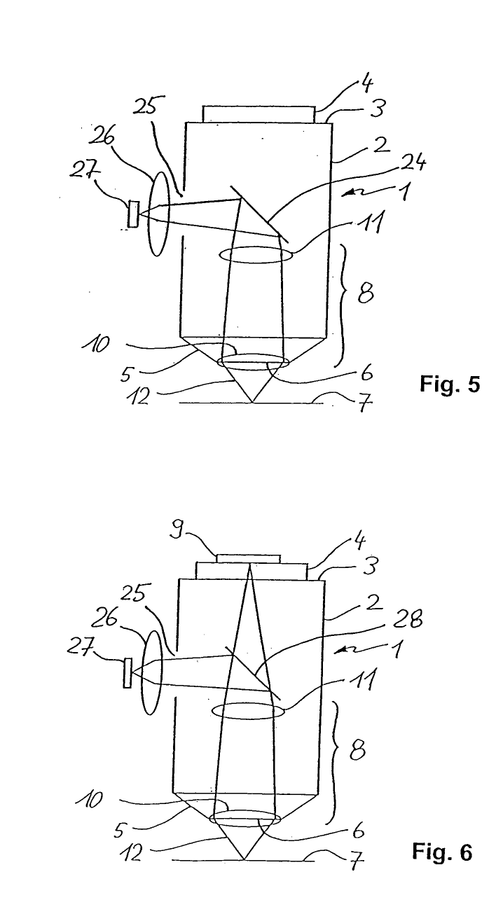

FIG. 5 shows a schematic view of a fifth embodiment of the microscope objective according to the invention, and

FIG. 6 shows a schematic view of a sixth embodiment of the microscope objective according to the invention.

The microscope objective 1 shown in FIG. 1 comprises a housing 2, the top surface 3 of which is provided with a screw thread 4 by which the microscope objective 1 may be screwed onto a revolving nosepiece (not shown) of a microscope (not shown).

In the bottom surface 5 of the housing 2, facing away from its top surface 3, a light inlet opening 6 is provided, through which the light coming from a specimen 7 may enter the housing 2. Inside the housing 2, an imaging optical system 8 is arranged by which a portion of the specimen may be imaged on an image-detecting element 9 mounted in the housing. In the embodiment presently shown, a CCD sensor is used as the image-detecting element 9.

In FIG. 1, the optical system 8 is formed from two schematically depicted lenses 10, 11, with lens 10 being positioned exactly within the light inlet opening 6. Further, FIG. 1 also shows an example of a beam path 12 for a location on the specimen 7.

Evaluation electronics 13 required for the image-detecting element 9 are attached to the outside of the housing 2, with the electrical image signals generated by the image-detecting element 9 being transmitted to the evaluation electronics 13 via a link (not shown).

The microscope objective 1 according to the invention has a diameter of about 30 mm and a length of about 40 mm, and the diagonal of the CCD sensor 9 is about 14 mm.

FIG. 2 shows a second embodiment of the microscope objective 1 according to the invention, wherein identical elements are identified by the same reference numerals, and their description is not repeated. In contrast to the embodiment shown in FIG. 1, the evaluation electronics 13 of the microscope objective 1 of FIG. 2 are not directly attached to the housing 2, but spaced apart therefrom (not shown). The evaluation electronics may, for example, be provided at a suitable location on the microscope, in which the microscope objective 1 is used. The connection may be established via electrical lines by means of a connecting element 14 provided on the housing 2, to which element the electrical signals of the image-detecting element 9 are applied.

Further, the housing 2 also contains a first and a second light source 15, 16, serving to illuminate the specimen 7 to be examined, with the beam paths 17, 18 of the illumination light being schematically depicted. In the embodiment shown in FIG. 2, the lens 10 of the optical system 8, said lens being arranged in the light inlet opening 6, is also used immediately for illumination using the light sources 15 and 16, so that it is possible to safeguard a compact assembly of the microscope objective 1.

A further embodiment of the microscope objective according to the invention is shown in FIG. 3, said embodiment differing from FIG. 1 only in that the image-detecting element 9 is mounted outside the housing 2 on the screw thread 4 and a light outlet opening extending through the top surface 3 as well as through the screw thread 4 is provided, which opening is at least as large as the image recording area of the image-detecting element 9. The remaining structure corresponds to that of FIG. 2, so that reference is made to the corresponding description.

Since the image-detecting element 9 is mounted on the screw thread 4 and, thus, no longer inside the housing 2, the manufacture of the microscope objective 1 according to the invention is very easy in terms of arranging the image-detecting element 9. Thus, the image-detecting element 9 may be fixed on the screw thread 4, e.g. by gluing. Further, the arrangement outside the housing 2 advantageously also allows the image-detecting element 9 to be easily exchanged, which is required, for example, if the image-detecting element 9 is defective.

A fourth embodiment of the microscope objective 1 according to the invention is shown in FIG. 4, wherein the arrangement of the image-detecting element 9 is effected, in this embodiment, in the same manner as in the embodiment shown in FIG. 3, and the evaluation electronics are not attached to the housing 2, but may be connected, in the same manner as in the embodiment shown iii FIG. 2, via the connecting element 14, to which the electrical signals of the image-detecting element 9 are applied.

In contrast to the previously described embodiments, the microscope objective 1 shown in FIG. 4 enables illumination of the specimen 7 in the manner of a known dark field illumination, because a dark field channel 19 is provided, which extends from the top surface 3 of the housing 2 to the bottom surface 5 and has a circular ring cross-section, so that it comprises a circular ring-shaped illumination-light inlet opening 20 at the top surface 3 and a circular ring-shaped illumination-light outlet area 21 at the bottom surface 5. When using the microscope objective 1 according to the invention in a microscope, light may be coupled into the dark field channel 19 via the illumination-light inlet opening 20, the specimen 7 then being illuminated with said light, as is evident from the schematically represented beam paths 22, 23.

FIG. 5 shows a fifth embodiment of the microscope objective 1 according to the invention, wherein identical elements which are also present in the previous embodiments are identified by the same reference numerals, and for their description, reference is made to the previous embodiments. In contrast to the previous embodiments, a deflecting element (e.g. a mirror) 24 is arranged in the housing 2 of the lens 11, which element deflects the incident light 90° to the left (as seen in FIG. 5). At the corresponding location in the side wall of the housing 2, a light outlet opening 25 is provided, so that the deflected light exits from the housing. Arranged following the light outlet opening 25 is an optical device 26, which is schematically depicted as a lens, said optical device 26 focussing the light onto an image-detecting element 27, which may be, for example, a CCD sensor.

The optical device 26 and the image-detecting element 27 may be either coupled to the housing 2 (preferably mechanically) or fixed relative to the microscope such that an optical coupling is provided when the microscope objective 1 is in the working position (i.e. when the microscope objective is in the working position, the light deflected by means of the deflecting element 24 is incident on the image-detecting element 27 via the optical device 26).

This arrangement allows to obtain a shorter objective length. At the same time, the beam path may be lengthened, so that, for example, more optical elements may be provided in the beam path between the specimen 7 and the image-detecting element 27. This allows, for example, to effect better optical corrections, and free selection of the focal length and of the image scale is thus also possible in a simple manner.

FIG. 6 shows a modification of the embodiment shown in FIG. 5, wherein, instead of the deflecting element 24, a beam splitter 28 is provided which only deflects part of the coupled-in light to the left, as seen in FIG. 6. The remaining part of the light passes through the beam splitter 28 and impinges on a second image-detecting element 9, which is mounted, in the same manner as in the embodiment shown in FIG. 3, on the screw thread 4 (there being provided, of course, a second light outlet opening (not shown) extending through the top surface 3 and through the screw thread 4). This embodiment advantageously allows simultaneous recording of two images by the two image-detecting elements 9 and 27, for example, with different magnifications.

It is also possible, of course, that in a modification of the embodiment shown in FIG. 6 the second image-detecting element 9 is not arranged outside the housing 2, but inside it. Further, if there is sufficient space in the housing 2, the optical device 26 may be partially or even completely arranged inside the housing.

In particular, the embodiments shown in FIGS. 5 and 6 also allow to omit the optical device 26, if the optical system 8 is accordingly designed, and in the embodiment of FIG. 6 optical elements may, of course, be arranged also between the beam splitter 28 and the second image-detecting element 9, if desired.

1. A microscope objective (1) comprising a housing (2), which is connectable to an objective mount of a microscope and comprises a light inlet opening (6), and further comprising an optical system (8) arranged inside the housing (2), characterized in that an image-detecting element (9; 27) is provided and that light entering through the light inlet opening (6) is directed to the image-detecting element (9; 27) by means of the optical system (8) and is not coupled into a beam path of the microscope, said beam path being located following the microscope objective (1).

2. The microscope objective (1) as claimed in claim 1, characterized in that the image-detecting element (9) is arranged inside the housing (2).

3. The microscope objective (1) as claimed in claim 1, characterized in that the housing (2) comprises a light outlet opening (25) and that the image-detecting element (27) is arranged outside the housing (2).

4. The microscope objective (1) as claimed in claim 3, characterized in that the image-detecting element (9) is attached to the outside of the housing (2) in such a manner that it covers the light outlet opening.

5. The microscope objective (1) as claimed in claim 3, characterized in that an optical device (26) is provided between the housing (2) and the image-detecting element (27).

6. The microscope objective (1) as claimed in any one of claims 1 to 5, characterized in that an evaluating device (13) is arranged outside the housing (2), said device being able to receive electrical image signals generated by the image-detecting element (9).

7. The microscope objective (1) as claimed in claim 6, characterized in that the evaluating device (13) is attached to the outside of the housing (2).

8. The microscope objective (1) as claimed in any one of claims 1 to 7, characterized in that the image-detecting element (9) is connected to the housing (2).

9. The microscope objective (1) as claimed in any one of claims 1 to 8, characterized in that a second image-detecting element (27) and a beam splitter (28) are provided, with the light entering through the light inlet opening (6) being split into two partial beam paths so as to illuminate both image-detecting elements (27, 9).

10. The microscope objective (1) as claimed in any one of claims 1 to 9, characterized in that the microscope objective (1) comprises a dark field channel (19) for illuminating a specimen (7) to be photographed.

11. The microscope objective (1) as claimed in any one of claims 1 to 10, characterized in that a light source (15; 16) is provided in the housing (2).

12. The microscope objective (1) as claimed in claim 11, characterized in that light from a light source (15; 16) may be output by at least a part (10) of the optical system (8) through the light inlet opening (6).

13. The microscope objective (1) as claimed in any one of claims 1 to 12, characterized in that the image-detecting element (9) comprises a CCD image sensor.

14. The use of the microscope objective (1) as claimed in any one of the preceding claims in a microscope comprising an objective mount, to which an observing objective is attached, and an optical observing system which is arranged following the objective mount and wherein specimen light received via the observing objective is coupled in if the observing objective is arranged in its working position using the objective mount, the microscope objective (1) being connected to the objective mount and movable into its working position by the latter.
